(19) United States
(12) Patent Application Publication
(10) Pub. No.: US 2026/0146161 A1
(43) Pub. Date: May 28, 2026

(54) XEROGEL TITANIUM OXIDE THIN FILM AND METHOD FOR MANUFACTURING THE SAME

(71) Applicant: KOREA ADVANCED INSTITUTE OF SCIENCE AND TECHNOLOGY, Yuseong-gu (KR)

(72) Inventor: Gonu KIM, Yangsan-si (KR)

(21) Appl. No.: 19/189,551

(22) Filed: Apr. 25, 2025

(30) Foreign Application Priority Data
Nov. 27, 2024 (KR) 10-2024-0171686
Mar. 17, 2025 (KR) 10-2025-0033933

(51) Int. Cl. C09D 1/00; B05D 3/00

(52) U.S. Cl. CPC C09D 1/00; B05D 3/007

(57) ABSTRACT

Provided are a method for manufacturing a titanium oxide (TiOₓ) thin film including: (S10) mixing a titanium precursor and a peroxide aqueous solution to prepare a gel mixture including a titanium oxide (TiOₓ); (S20) heating the gel mixture to prepare a titanium oxide (TiOₓ) gel from which a peroxotitanic acid precipitate, a peroxide, and water have been removed; (S30) preparing a dispersion in which the titanium oxide (TiOₓ) gel is dispersed in a solvent; (S40) applying the dispersion on a substrate; and (S50) heat treating the substrate on which the dispersion has been applied, and a titanium oxide (TiOₓ) thin film manufactured therefrom.

### CROSS-REFERENCE TO RELATED APPLICATIONS

This application claims priority under 35 U.S.C. § 119 to Korean Patent Application No. 10-2024-0171686, filed on Nov. 27, 2024, and Korean Patent Application No. 10-2025-0033933, filed on Mar. 17, 2025, in the Korean Intellectual Property Office, the disclosure of which is incorporated herein by reference in its entirety.

### TECHNICAL FIELD

The following disclosure relates to a xerogel titanium oxide (TiOₓ) thin film and a method for manufacturing the same.

### BACKGROUND

A titanium oxide-based thin film including titanium dioxide is being widely used in various industrial fields such as a UV blocking film, a photocatalyst, and a corrosion inhibitor. In particular, since a transparent titanium oxide thin film shows excellent adhesion strength due to a high contact area with a substrate while maintaining the appearance of a product, it has a very high industrial value.

Currently, in order to manufacture a structurally homogeneous titanium oxide thin film, a high energy process such as e-beam evaporation, sputtering evaporation, and atmospheric pressure chemical vapor deposition is being used. However, the method needs high priced equipment and has a problem of high manufacturing costs. As an alternative to overcome the limitation, a sol-gel method is receiving attention. The sol-gel method is an economical manufacturing method allowing large area coating with low costs, and is a synthesis method in which a precursor such as a metal alkoxide or a metal salt in a solution state is converted into an oxide solid through hydrolysis and a condensation reaction.

However, in spite of the excellent industrial utility of the sol-gel method, there was a difficulty in manufacturing a structurally homogeneous titanium oxide thin film by the sol-gel method. The main cause is that since titanium oxide nanoparticles form a heterogeneous precipitate, it is difficult to process them into a homogeneous thin film.

As a method for solving the problem, manufacture by the sol-gel method of the xerogel titanium oxide thin film has been suggested. This is a method in which after synthesizing titanium oxide gel instead of nanoparticles by a sol-gel method, the gel is shrunk densely by a drying process to manufacture a xerogel titanium oxide thin film. The xerogel thin film manufactured as such has high structural homogeneity and light scattering and reflection are minimized to show excellent transparent and adhesion properties.

However, there is still a difficulty in synthesizing a xerogel titanium oxide thin film. The biggest problem is that it takes a long time to synthesize a titanium oxide gel. Since the hydrolysis rate of the titanium precursor is very fast, when the rate is not appropriately controlled, the precipitate of nanoparticles is formed before forming gel by a condensation reaction. Therefore, in order to form a titanium oxide gel, the hydrolysis rate should be made very slow by water supply control through chemical modification or an esterification reaction of the titanium precursor and the like, and thus, it may take several weeks or more just to manufacture a gel. In addition, in the process of manufacturing the synthesized gel into a xerogel thin film, a gel structure may easily collapse or a heterogeneous thin film is formed from the precipitate and other impurities, which remains a difficult problem.

### SUMMARY

An embodiment of the present disclosure is directed to providing a method for manufacturing a titanium oxide (TiOₓ) thin film and a titanium oxide thin film (TiOₓ) manufactured therefrom. The titanium oxide thin film may be a xerogel titanium oxide (TiOₓ) thin film, and the titanium oxide (TiOₓ) may be titanium dioxide.

Another embodiment of the present disclosure is directed to providing a method for manufacturing a high-quality titanium oxide (TiOₓ) thin film within a short time.

Another embodiment of the present disclosure is directed to providing a structurally homogeneous titanium oxide (TiOₓ) thin film and a method for manufacturing the same.

Another embodiment of the present disclosure is directed to providing a titanium oxide (TiOₓ) thin film having an excellent corrosion inhibition effect and a method for manufacturing the same.

Still another embodiment of the present disclosure is directed to providing a titanium oxide (TiOₓ) thin film having excellent adhesion without a binder and a method for manufacturing the same.

In one general aspect, a method for manufacturing a titanium oxide (TiOₓ) thin film includes: (S10) mixing a titanium precursor and a peroxide aqueous solution to prepare a gel mixture including a titanium oxide (TiOₓ); (S20) heating the gel mixture to prepare a titanium oxide (TiOₓ) gel from which a peroxotitanic acid precipitate, a peroxide, and water have been removed; (S30) preparing a dispersion in which the titanium oxide (TiOₓ) gel is dispersed in a solvent; (S40) applying the dispersion on a substrate; and (S50) heat treating the substrate on which the dispersion has been applied.

In an exemplary embodiment, in (S10), the peroxide aqueous solution may be added in a divided manner.

In an exemplary embodiment, in (S30), the dispersion may be prepared by sonicating a solvent to which the titanium oxide gel has been added.

In an exemplary embodiment, in (S20), the heating may be performed under temperature conditions of 50 to 200° C.

In an exemplary embodiment, in (S50), the heat treating may be performed for 1 minute to 24 hours.

In an exemplary embodiment, the titanium precursor may include titanium alkoxides.

In an exemplary embodiment, (S40) and (S50) may be set as a unit process and the unit process may be performed at least once.

In an exemplary embodiment, (S50) may be performed at 10 to 1000° C.

In another general aspect, a xerogel titanium oxide (TiOₓ) thin film manufactured by method described above is provided.

In an exemplary embodiment, the xerogel titanium oxide (TiOₓ) thin film may have a light transmittance of 70% or more in a wavelength band of 300 to 800 nm.

In an exemplary embodiment, the xerogel titanium oxide (TiOₓ) thin film may have a corrosion inhibition efficiency represented by the following Equation 1 of 65% or more:

$$Corrosion inhibition efficiency ( \% ) = ( 1 - \frac{C {R}_{coated}}{C {R}_{uncoated}} ) \times 100 \% \qquad [ Equation 1 ]$$

wherein CR_{coated} is a corrosion degree of a substrate including the xerogel titanium oxide (TiOₓ) thin film, and CR_{uncoated} is a corrosion degree of a substrate which does not include the xerogel titanium oxide (TiOₓ) thin film.

Other features and aspects will be apparent from the following detailed description, the drawings, and the claims.

### BRIEF DESCRIPTION OF THE DRAWINGS

FIG. 1 is XRD analysis spectra of titanium oxide thin films manufactured in Examples 2 to 5 and Comparative Example 1, respectively.

FIG. 2A is a transmission electron microscope image of the titanium oxide thin film according to Example 4, and

FIG. 2B is a transmission electron microscope image of the titanium oxide thin film according to Comparative Example 1.

FIG. 3A is a graph of measuring UV-visible transmittance spectra of the titanium oxide thin films according to Examples 2 to 5, and FIG. 3B is a graph of measuring UV-visible transmittance spectra of the titanium oxide thin films according to Examples 6 to 11 and Comparative Example 2 (P25/quartz).

FIG. 4A is a graph of measuring photocurrent production and FIG. 4B is a graph of measuring a steady state photocurrent production of the titanium oxide thin films manufactured by the methods according to Comparative Example 1 (P25/FTO) and Example 4 (T550/FTO).

FIG. 5A is polarization curves of bare Al alloy and the titanium oxide thin films according to Example 12 (T25/Al alloy), Example 13 (T110/Al alloy), and Comparative Example 3 (P25/Al alloy), and FIG. 5B is polarization curves of bare Cu and the titanium oxide thin films according to Example 15 (T25/Cu), Example 16 (T110/Cu), and Comparative Example 4 (P25/Cu).

FIG. 6A is an image showing immersion corrosion test results of Example 13 (T110/Al alloy) and bare aluminum alloy panel (Bare Al alloy), and FIG. 6B is a schematic diagram showing the immersion corrosion test method.

### DETAILED DESCRIPTION OF EMBODIMENTS

A xerogel titanium oxide (TiOₓ) thin film and a method for manufacturing the same of the present disclosure will be described in detail. The terms used in the present specification are selected to be as common as possible and are currently widely used while considering the function of the present disclosure, but they may vary depending on the intention of a person skilled in the art, a convention, the emergence of new technology, or the like. The technical and scientific terms used may have, unless otherwise defined, the meaning commonly understood by those of ordinary skill in the art.

The terms such as “comprise” or ““have” in the present specification and the appended claims mean that there is a characteristic or a constitutional element described in the specification, and as long as it is not particularly limited, a possibility of adding one or more other characteristics or constitutional elements is not excluded in advance.

In the present specification and the appended claims, the terms such as “first” and “second” are not used in a limited meaning but are used for the purpose of distinguishing one constituent element from other constituent elements.

A singular expression in the present specification and the appended claims includes a plural expression, unless otherwise explicitly specified as singular. In addition, a plural expression includes a singular expression, unless otherwise explicitly specified as plural.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present disclosure, values which may be outside a numerical range due to experimental error or rounding off of a value are also included in the defined numerical range.

The term of degree “about” and the like used in the present specification and the attached claims are used in the sense of covering an allowable error when the allowable error exists.

In order to manufacture a structurally homogeneous titanium oxide (TiOₓ) thin film having high industrial utility value, a high energy process such e-beam evaporation, sputtering evaporation, and atmospheric pressure chemical vapor deposition mainly for manufacturing a titanium oxide thin film is being used, and a sol-gel method which has been developed for solving a high manufacturing cost problem has a difficulty such as formation of precipitates such as titanium oxide nanoparticles before a gel is formed by a condensation reaction when it is not appropriately controlled, due to a rapid hydrolysis rate of a titanium precursor. Therefore, in order to form a titanium oxide (TiOₓ) gel using the sol-gel method, the hydrolysis rate should be very low, and it takes a very long manufacturing time approaching several weeks or more. Also, a problem in which during a drying process of manufacturing the gel into a xerogel thin film, a gel structure collapses easily to form a heterogeneous thin film remains an important problem to be solved.

Thus, the present applicant conducted an in-depth study, and developed a method for manufacturing a titanium oxide (TiOₓ) thin film which may manufacture a titanium oxide (TiOₓ) thin film within a short time and may not collapse the structure of a titanium oxide (TiOₓ) gel during manufacture to manufacture a structurally homogeneous, high-quality titanium oxide (TiOₓ) thin film, so that adhesion between the titanium oxide (TiOₓ) thin film and a substrate is excellent without including a binder and a corrosion inhibition effect is excellent.

A method for manufacturing a titanium oxide (TiOₓ) thin film according to the present disclosure includes: (S10) mixing a titanium precursor and a peroxide aqueous solution to prepare a gel mixture including a titanium oxide (TiOₓ); (S20) heating the gel mixture to prepare a titanium oxide (TiOₓ) gel from which a peroxotitanic acid precipitate, a peroxide, and water have been removed; (S30) preparing a dispersion in which the titanium oxide (TiOₓ) gel is dispersed in a solvent; (S40) applying the dispersion on a substrate; and (S50) heat treating the substrate on which the dispersion has been applied.

According to a series of manufacturing methods of the present disclosure, a titanium oxide (TiOₓ) thin film which does not collapse, and has structurally homogeneous characteristics may be rapidly manufactured, and in particular, a xerogel titanium oxide (TiOₓ) thin film having excellent light transmittance and excellent corrosion inhibition efficiency, may be manufactured therefrom.

In an exemplary embodiment, the titanium oxide (TiOₓ) may refer to a titanium oxide having various oxidation states, in which x may be a value between 0.5 and 2.0. Specifically, the titanium oxide may refer to a titanium compound including the oxidation state of titanium dioxide (TiO₂). For example, the titanium oxide may refer to being formed of titanium dioxide (TiO₂) or including mainly the oxidation state of titanium dioxide and some other oxidation states (e.g., Tio, Ti₂O₃) or an amorphous composition. The oxidation state of the titanium oxide (TiOₓ), that is, the number of oxygens indicated as an x value may change depending on heating conditions, heat treatment condition, and the like, and this may be affected by an oxygen deficiency state or presence of a peroxide bond (O—O).

As a non-limiting example, in (S50), when the heat treatment temperature is low temperature conditions of 25° C. to 450° C., an amorphous titanium oxide structure mainly formed of a Ti—O—Ti bond network may be dominant in titanium oxide (TiOₓ), and this structure may partially include a peroxide bond (O—O). Otherwise, in the titanium oxide (TiOₓ) under the high temperature conditions of 450° C. to 1000° C., mainly a titanium dioxide (TiO₂) structure may be dominant.

In the manufacturing method of the present disclosure, in (S10), a titanium precursor and a peroxide aqueous solution are mixed, thereby manufacturing a gel mixture including titanium oxide (TiOₓ) by a hydrolysis reaction and a condensation reaction between a titanium precursor and a peroxide aqueous solution. The reaction of the titanium precursor and the peroxide aqueous solution involves an exothermic reaction, resulting in a rapid condensation reaction of peroxotitanic acid at a high temperature and formation of a titanium oxide (TiOₓ) gel within a short time.

In an exemplary embodiment, the titanium precursor may have a functional group which may react with a peroxide aqueous solution to be hydrolyzed, and specifically, the titanium precursor may include titanium alkoxides. As an example, the titanium alkoxide may include one or more selected from titanium t tetraisopropoxide, titanium n-butoxide, and titanium ethoxide, and more specifically, may include titanium tetraisopropoxide, but the present disclosure may not be limited to the specific kinds of titanium precursors.

As an example, the peroxide aqueous solution may include hydrogen peroxide; and/or metal peroxides such as magnesium peroxide (MgO₂), calcium peroxide (CaO₂), and sodium peroxide (Na₂O₂) which react with water to produce hydrogen peroxide, and more specifically, may include a hydrogen peroxide aqueous solution, but the present disclosure is not necessarily limited to the specific kind of the peroxide aqueous solution.

As a specific example, when titanium tetraisopropoxide as the titanium precursor and hydrogen peroxide water as the peroxide aqueous solution are used, (S10) may involve the following Reaction Formulae 1 and 2. When the titanium precursor is mixed with the peroxide aqueous solution, first, the titanium precursor and water may react to produce titanium hydroxide (Ti(OH)₄), as shown in the following Reaction Formula 1. Thereafter, titanium hydroxide and hydrogen peroxide may react to produce a peroxotitanic acid aqueous solution, as shown in the following Reaction Formula 2. The peroxotitanic acid aqueous solution may form titanium oxide (TiOₓ) in a gel form by a condensation reaction between a hydroxyl group or a peroxide group.

Ti(OC(CH₃)₂)₄+4H₂O→Ti(OH)₄+4(CH(CH₃)₂OH) [Reaction Formula 1]

Ti(OH)₄+nH₂O₂→(HO)₄₋ₙ—Ti—(OOH)ₙ+nH₂O [Reaction Formula 2]

In an exemplary embodiment, the peroxide and the titanium precursor may stably react in an aqueous solution, and some peroxotitanic acid which does not participate in the condensation reaction in (S10) may be concentrated to form a peroxotitanic acid precipitate. In addition, in (S10), the gel mixture prepared may include not only a peroxotitanic acid precipitate but also incidentally peroxide, water, and the like with titanium oxide, and the peroxotitanic acid precipitate, the peroxide, and water may be removed later in (S20).

In a specific example, a volume ratio between the titanium precursor and the peroxide aqueous solution may be 1:1 to 25. The volume ratio between the titanium precursor and the peroxide aqueous solution may be 1:1 or more, 1:5 or more, 1:7 or more, 1:10 or more, 1:12 or more, 1:13 or more, 1:14 or more or a value between them as the lower limit, and 1:25 or less, 1:22 or less, 1:20 or less, 1:18 or less, 1:17 or less, 1:16 or less, or a value between them as the upper limit.

As an exemplary embodiment, the peroxide aqueous solution may include 20 to 50 wt % of the peroxide. The lower limit may be 20 wt % or more, 23 wt % or more, 25 wt % or more, 26 wt % or more, 27 wt % or more, or a value between them, and the upper limit may be 50 wt % or less, 45 wt % or less, 40 wt % or less, 35 wt % or less, 33 wt % or less, 32 wt % or less, 31 wt % or less, 30 wt % or less, 29 wt % or less, or a value between them. However, the concentration of the peroxide aqueous solution is not necessarily limited thereto.

In a specific example, a weight ratio of the peroxide included in the titanium precursor and the peroxide aqueous solution may be 1:1 to 6. The lower limit may be 1:1 or more, 1:3 or more, 1:4 or more, 1:4.5 or more, or a value between them, and the upper limit may be 1:6 or less, 1:5.5 or less, 1:5 or less, 1:4.9 or less, 1:4.8 or less, or a value between them.

When the weight ratio or the volume ratio described above is satisfied, a reaction of the titanium precursor and the peroxide aqueous solution may sufficiently occur and the peroxotitanic acid precipitate may be small.

In an exemplary embodiment, in (S10), the peroxide aqueous solution may be added all at once, but preferably may be added in a divided manner. Specifically, the peroxide aqueous solution may be divided into once or more or twice or more as the lower limit, 10 times or less, 7 times or less, 5 times or less, 3 times or less, 2 times or less, or the number corresponding to the value between them as the upper limit and mixed. When added in a divided manner, formation of the peroxotitanic acid precipitate which is produced incidentally in the reaction process of the peroxide aqueous solution may be minimized, as compared with the case of adding all at once.

In an exemplary embodiment, in (S10), the concentration of the peroxide aqueous solution which is further added when adding the peroxide aqueous solution in a divided manner may be the same as or different from the concentration of the peroxide aqueous solution when first added. In addition, in an exemplary embodiment, (S10) may further include individually heating between each addition step of the peroxide aqueous solution to further promote peroxotitanic acid precipitate dissolution and the condensation reaction.

As an exemplary embodiment, in (S10), when the peroxide aqueous solution is added in a divided manner into two portions, (S10) may include (S11) first mixing the titanium precursor and a first peroxide aqueous solution; and (S12) second mixing the first mixture and a second peroxide aqueous solution. By adding in a divided manner and mixing the peroxide aqueous solution as described above to prepare a gel mixture including titanium oxide (TiOₓ), the peroxotitanic acid precipitate produced in the process may be minimized to manufacture a high quality titanium oxide (TiOₓ) thin film. As a more peroxotitanic acid precipitate is formed, the precipitate may not be sufficiently removed, and as a result, when a titanium oxide gel is applied on a substrate, the application may not be evenly performed due to the remaining peroxotitanic acid precipitate and it may be difficult to form a homogeneous titanium oxide (TiOₓ) thin film.

In an exemplary embodiment, in (S20), the peroxotitanic acid may be removed more effectively by adding the peroxide aqueous solution in a divided manner in (S10). More specifically, in the process of evaporating the peroxide aqueous solution by an exothermic reaction between the titanium precursor and the peroxide aqueous solution in the first mixing (S11), a peroxotitanic acid precipitate may be produced. Thus, the peroxide aqueous solution is further added to the first mixture to perform second mixing as in (S12), and then the mixture is heated in (S20), thereby dissolving a peroxotitanic acid precipitate remaining in the gel mixture including the titanium oxide to make it participate in the condensation reaction. Most of the peroxotitanic acid is consumed by a condensation reaction therefrom, the peroxotitanic acid precipitate from a combination of (S10) and (S20) is finally removed from the gel mixture including the titanium oxide (TiOₓ), and there almost no peroxotitanic acid in the prepared titanium oxide (TiOₓ) gel or the peroxotitanic acid may be removed therefrom.

In a specific example, the peroxide aqueous solution in (S10) may be added in a divided manner twice or more, specifically 2 to 5 times. Preferably, adding in a divided manner twice or more may be effective for suppressing the formation of the peroxotitanic acid precipitate and removing it, and may be more efficient in the process considering the process of removing a peroxide and water.

In a specific example, a volume ratio between the first peroxide aqueous solution and the second peroxide aqueous solution when added in a divided manner may be 1:1 to 4, specifically 1:1 or more, 1:1.3 or more, 1:1.5 or more, 1:1.8 or more, 1:2.0 or more, or a value between them as the lower limit, and 1:4 or less, 1:3.5 or less, 1:3 or less, 1:2.7 or less, 1:2.5 or less, 1:2.3 or less, 1:2.1 or less, 1:2 or less, or a value between them as the upper limit. When the peroxide aqueous solution is added at the volume ratio, the hydrolysis reaction may be stably performed, the peroxotitanic acid precipitate may be easily dissolved. In addition, when added in a divided manner N times, a larger volume may be added from the first peroxide aqueous solution to the N^{th} peroxide aqueous solution, and as an example, the volume ratio between the first peroxide aqueous solution and the N^{th} peroxide aqueous solution may satisfy 1:1 to 4.

In addition, as an exemplary embodiment, a heating step (S11-H) may be further included between (S11) and (S12), and the dissolution and the condensation reaction of the peroxotitanic acid precipitate may be promoted therefrom to minimize the formation of the precipitate. As an example, the heating conditions of (S11-H) may be identical or similar to the heating conditions of (S20).

Next, in (S20), the gel mixture including titanium oxide may be heated to dissolve the peroxotitanic acid precipitate in the gel mixture produced in (S10) and remove it, and also remove peroxide and water. A structurally homogeneous titanium oxide (TiOₓ) gel may be prepared therefrom.

In a specific example, in (S20), the heating may be performed under temperature conditions of 50 to 200° C. The temperature conditions may be 50° C. or higher, 70° C. or higher, 90° C. or higher, 100° C. or higher, or a value between them as the lower limit, and 200° C. or lower, 180° C. or lower, 160° C. or lower, 150° C. or lower, 140° C. or lower, 120° C. or lower, or a value between them as the upper limit. When the gel mixture including titanium oxide (TiOₓ) is heated in the temperature range, the dissolution and the condensation reaction of the peroxotitanic acid precipitate are promoted, thereby easily removing the peroxotitanic acid precipitate, and the peroxide and water may be selectively removed.

In addition, in (S20), the heating may be performed for 1 minute to 1 hour. The heating time conditions may be 1 minute or more, 3 minutes or more, 5 minutes or more, 10 minutes or more, 15 minutes or more, 20 minutes or more, 30 minutes or more, or a value between them as the lower limit and 1 hour or less, 50 minutes or less, 40 minutes or less, 30 minutes or less, 20 minutes or less, 10 minutes or less, 8 minutes or less, 6 minutes or less, 5 minutes or less, or a value between them as the upper limit. The peroxotitanic acid precipitate may be removed by performing heating in the time range to perform the dissolution and the condensation reaction of the peroxotitanic acid precipitate, and the peroxide and water may also be rapidly removed by thermal decomposition.

As a contrasting example, when the gel mixture including a titanium oxide is applied on a substrate as it is without the heating process of (S20) and dried, a peroxide remaining in the gel mixture may be rapidly decomposed and produce oxygen bubbles. The oxygen bubbles may make the pore size distribution inside the titanium oxide (TiOₓ) thin film irregular to cause a difference in a capillary force acting at an interface of pores inside the gel, and as a result, the internal structure of the titanium oxide thin film may collapse and the titanium oxide (TiOₓ) thin film may form an agglomerate and be separated from the surface of the substrate.

In an exemplary embodiment, when the peroxide removed in (S20) is hydrogen peroxide, the titanium oxide (TiOₓ) gel from which the peroxotitanic acid precipitate, the peroxide, and water have been removed may include the hydrogen peroxide at 1 wt % or less, 0.7 wt % or less, 0.5 wt % or less, 0.3 wt % or less, 0.1 wt % or less, 0.01 wt % or less, or a value between them as the upper limit, based on the total weight, and advantageously, the titanium oxide (TiOₓ) gel from which the peroxotitanic acid precipitate, the peroxide, and water have been removed may not include hydrogen peroxide.

In an exemplary embodiment, the titanium oxide (TiOₓ) gel from which the peroxotitanic acid precipitate, the peroxide, and water have been removed may include the peroxotitanic acid precipitate at 1 wt % or less, 0.7 wt % or less, 0.5 wt % or less, 0.3 wt % or less, 0.1 wt % or less, 0.01 wt % or less, or a value between them as the upper limit, based on the total weight, and advantageously, the titanium oxide (TiOₓ) gel from which the peroxotitanic acid precipitate, the peroxide, and water have been removed may not include peroxotitanic acid precipitate.

Next, in the method for manufacturing a titanium oxide (TiOₓ) thin film of the present disclosure, the titanium oxide (TiOₓ) gel produced from (S20) is dispersed in a solvent again and applied on a substrate to manufacture a titanium oxide (TiOₓ) thin film, thereby suppressing production of a titanium oxide (TiOₓ) agglomerate so that the internal structure of the titanium oxide (TiOₓ) thin film does not collapse, and thus, a more homogeneous titanium oxide thin film may be manufactured.

Specifically, the titanium oxide (TiOₓ) gel from which the peroxotitanic acid precipitate, water, and the peroxide have been removed may be dispersed in a solvent through (S30). In an exemplary embodiment, (S30) may sonicating the solvent added to the titanium oxide (TiOₓ) gel from which the peroxotitanic acid precipitate, the hydroperoxide, and water have been removed and then recovering a supernatant to prepare a dispersion. Since impurities including a small amount of the peroxide remaining in the titanium oxide (TiOₓ) gel are removed and the titanium oxide (TiOₓ) gel is uniformly and highly dispersed by sonication, agglomeration formation of the titanium oxide (TiOₓ) in (S40) and (S50) described later is suppressed, and thus, a high quality titanium oxide (TiOₓ) thin film having a homogeneous structure may be formed.

In an exemplary embodiment, the solvent in the dispersion may not be limited as long as it may disperse the titanium oxide (TiOₓ) gel without dispersing it. Also, the solvent in the dispersion may be used without limitation as long as it does not react with the peroxotitanic acid which may remain and may dissolve it.

As an example, the solvent of the dispersion may include one or more selected from alcohol-based solvents, water, acetone, acetonitrile, dimethylformamide (DMF), dimethyl sulfoxide (DMSO), ethyl acetate, dichloromethane, and dimethylacetamide (DMAc), and preferably, may include alcohol-based solvents. The alcohol-based solvent may include straight chain or branched alkanol having 1 to 8 carbon atoms, and more specifically, the alcohol-based solvent may include ethanol, isopropyl alcohol, octanol, butanol, and the like, but the present disclosure is not limited to the specific kind of solvent.

Next, the dispersion prepared in (S30) is applied on a substrate in (S40), and then the substrate on which the dispersion has been applied is heat treated and dried in (S50), thereby manufacturing a titanium oxide (TiOₓ) thin film. After removing the peroxide and the peroxotitanic acid precipitate present in the gel mixture, the dispersion in which the titanium oxide gel is dispersed in the solvent is applied on the substrate and heat treated, thereby removing the peroxotitanic acid precipitate without producing oxygen bubbles by a peroxide, and thus, the manufacturing method of the present disclosure may suppress collapse of the structure of the titanium oxide gel or formation of a non-uniform coating. In addition, since the titanium oxide (TiOₓ) thin film having a homogeneous structure without collapse of the gel structure has excellent adhesion to the substrate without a binder, problems of discoloration, decomposition or thin quality deterioration by the binder may be prevented.

In an exemplary embodiment, in the manufacturing method of the present disclosure, (S40) and (S50) may be set as a unit process, and the unit process may be performed at least once. For description with an example, the unit process is repeated, for example, first application and first heat treatment, second application and second heat treatment, . . . , N^{th} application and N^{th} heat treatment, of the dispersion are performed to precisely adjust the thickness of the titanium oxide (TiOₓ) thin film. Even when the titanium oxide (TiOₓ) thin film thickens, it has a continuous layer, and thus, defects on or inside the surface of the titanium oxide (TiOₓ) thin film are minimized, thereby manufacturing a titanium oxide (TiOₓ) thin film having high transparency.

As a non-limiting example, the unit process may be repeated 1 to 20 times, 1 to 18 times, 1 to 16 times, 1 to 14 times, 1 to 12 times, 1 to 10 times, or a value between the numerical range, thereby adjusting the thickness of the titanium oxide (TiOₓ) thin film. Otherwise, the unit process may be performed once or more, twice or more, 4 times or more, 6 times or more, 8 times or more, or a value between them as the lower limit, and 20 times or less, 18 times or less, 16 times or less, 14 times or less, 12 times or less, 10 times or less, 9 times or less or a value between them as the upper limit. In particular, when the titanium oxide (TiOₓ) thin film is manufactured by repeating the unit process 2 to 20 times, 4 to 18 times, 6 to 16 times, or 8 to 14 times, a light absorption rate in a wavelength band of 200 to 400 nm, more specifically a UV wavelength band of 250 to 350 nm is significantly increased and the thin film may have an advantage of an excellent effect as a UV blocking agent.

As an example, (S40) may be performed by applying the dispersion on a substrate using a common solution coating method, and for example, a method such as spin coating, blade coating, roll to roll coating, spray coating, dip coating, Gravure coating, reverse offset coating, screen printing, slot-die coating, and nozzle printing may be adopted, but the present disclosure is not limited to the dispersion application method.

In an exemplary embodiment, the substrate on which the dispersion is applied may be appropriately selected depending on the use of the titanium oxide (TiOₓ) thin film, and for example, a transparent conductive oxide (TCO) such as F-doped tin oxide (FTO) and indium tin oxide (ITO); quartz; metal such as aluminum, an aluminum alloy, and copper may be used as a substrate, but the present disclosure is not limited to the type of substrate, of course.

In an exemplary embodiment, in (S50), the heat treatment temperature may be 10 to 1000° C., 15 to 900° C., 20 to 700° C., or 25 to 650° C. Otherwise, it may be 10° C. or higher, 15° C. or higher, 20° C. or higher, 25° C. or higher, or a value between them as the lower limit and 1000° C. or lower, 900° C. or lower, 800° C. or lower, 700° C. or lower, 650° C. or lower, or a value between them as the upper limit, or may be in a range between any two values of the numerical values.

In an exemplary embodiment, the crystal structure of the finally manufactured titanium oxide (TiOₓ) thin film may be controlled by adjusting the heat treatment temperature in (S50). For example, when (S50) is performed at a temperature of lower than 500° C., 480° C. or lower, 460° C. or lower, specifically 450° C. or lower as the upper limit, an amorphous titanium oxide (TiOₓ) thin film may be manufactured, and when the heat treatment is performed in the temperature conditions of 450° C. or higher, 470° C. or higher, 490° C. or higher, specifically 500° C. or higher as the lower limit, a crystalline titanium oxide (TiOₓ) thin film in which at least a part of the titanium oxide (TiOₓ) thin film includes an anatase phase, a rutile phase, or a combination thereof may be formed.

In addition, as an example, the titanium oxide (TiOₓ) thin film having an amorphous structure prevents an external fluid from being introduced to the substrate to have an excellent corrosion inhibition effect, and when the titanium oxide (TiOₓ) thin film includes a crystallin phase, it has a photocatalytic activity and may be used as a photocatalyst film.

In an exemplary embodiment, (S50) may be performed for 1 minute to 24 hours, 2 minutes to 18 hours, 3 minutes to 16 hours, 4 minutes to 14 hours, 5 minutes to 12 hours, or a time between the numerical range. The lower limit may be 1 minute or more, 3 minutes or more, 5 minutes or more, 10 minutes or more, 30 minutes or more, 1 hour or more, or a time between the values, and the upper limit may be 24 hours or less, 20 hours or less, 18 hours or less, 16 hours or less, 14 hours or less, 12 hours or less, 10 hours or less, 6 hours or less, 3 hours or less, 1 hour or less, 30 minutes or less, or a time between the values. In the present disclosure, the manufacturing time of the titanium oxide (TiOₓ) thin film is shortened by the method described above, thereby manufacturing a high quality titanium oxide thin film of which the titanium oxide (TiOₓ) thin film structure does not collapse even when it is heat treated faster in less time.

The present disclosure includes a xerogel titanium oxide (TiOₓ) thin film manufactured by method described above. As described above, a titanium precursor and a peroxide aqueous solution are mixed to prepare a gel mixture including a titanium oxide (TiOₓ) in (S10), a peroxotitanic acid precipitate, water, and a peroxide present in the gel mixture is removed, and heated and dried in (S20), a titanium oxide gel is dispersed in a solvent to suppress agglomeration of titanium oxide particles in (S30), thereby finally performing a heat treatment in (S50) to densely shrink the thin film to manufacture a structurally homogeneous titanium oxide (TiOₓ) thin film. The xerogel titanium oxide (TiOₓ) thin film having a homogeneous structure has small light scattering and reflection to have high transparency.

As an example, a light transmittance in a wavelength band of 300 to 800 nm, 350 to 750 nm, 400 to 700 nm, or 450 to 700 nm may be 65% or more, 68% or more, 70% or more, 73% or more, 75% or more, or a value between them, and advantageously, may be 75% or more, as the lower limit. Since the light transmittance in the wavelength band, that is, a visible light wavelength band is significantly high, transparency may be excellent.

In a specific example, the light transmittance in a UV wavelength band, specifically in a wavelength band of 200 to 400 nm or 250 to 350 nm may be less than 15%, less than 12%, less than 10%, less than 9%, less than 8% or a value between them, and narrowly less than 8% as the upper limit. Since the light transmittance to visible light is high, but light is effectively absorbed in the UV wavelength band in the range, it may be applied as a UV absorption film.

The xerogel titanium oxide (TiOₓ) thin film according to the present disclosure may have high adhesion by a strong interaction with a substrate. Since the titanium oxide (TiOₓ) thin film is not peeled off from the substrate even when a separate binder is not included, the durability and the lifespan of the thin film may be increased. When the titanium oxide (TiOₓ) thin film of the present disclosure is used as a photocatalyst, a high catalytic activity may be maintained for a long time.

Furthermore, the xerogel titanium oxide (TiOₓ) thin film which is condensely shrunk without surface or internal defects may effectively block introduction of a fluid into the substrate to effectively suppress corrosion of the substrate.

As an example, the xerogel titanium oxide (TiOₓ) thin film may have a corrosion inhibition efficiency represented by the following Equation 1 of 65% or more, 66% or more, or 67% or more, preferably 70% or more, 73% or more, 75% or more, or 80% or more, and most preferably 90% or more, 95% or more, or a value between them or more, as the lower limit. In the following Equation 1, CR_{coated} is a corrosion degree of a substrate including the xerogel titanium oxide (TiOₓ) thin film, and CR_{uncoated} is a corrosion degree of a substrate which does not include the xerogel titanium oxide (TiOₓ) thin film:

$$Corrosion inhibition efficiency ( \% ) = ( 1 - \frac{C {R}_{coated}}{C {R}_{uncoated}} ) \times 100 \% . \qquad [ Equation 1 ]$$

Although the exemplary embodiments of the present disclosure have been described above, the present disclosure is not limited to the exemplary embodiments but may be carried out in various forms different from each other, and those skilled in the art will understand that the present disclosure may be implemented in other specific forms without departing from Inventive steel technical spirits or the essential feature of the present invention. Therefore, it should be understood that the exemplary embodiments described above are not restrictive, but illustrative in all aspects.

Hereinafter, the present disclosure will be described in more detail by the experimental examples.

### (Example 1) Manufacture of T25/FTO

1 mL of titanium tetraisopropoxide (Junsei) and 5 mL of a peroxide aqueous solution (28%, Duksan) were mixed and reacted for 5 minutes to produce a light yellow solid. 10 mL of a hydrogen peroxide aqueous solution (28%, Duksan) was added to the produced solid and mixed to prepare a mixture in a gel form. A container containing the mixture was placed in an oven, and heated and dried at 110° C. for 5 minutes. Thereafter, the container was taken out, 20 mL of ethanol was added, sonication was performed, and a supernatant was recovered to prepare a dispersion. 10 μl of the dispersion was applied by drop coating on an FTO (F-doped Tin Oxide) (visionLab Science, TEC 7) substrate having a size of 1×1 cm², and a heat treatment was performed at 25° C. for 12 hours to manufacture a titanium oxide thin film. This was named T25/FTO.

### (Example 1-1) Addition of Peroxide Aqueous Solution all Together (5 mL)

The process was performed in the same manner as in Example 1, except that 1 mL of titanium tetraisopropoxide and 5 mL of a hydrogen peroxide aqueous solution were mixed and reacted without further addition of the hydrogen peroxide aqueous solution, and then heated and dried.

### (Example 1-2) Addition of Peroxide Aqueous Solution all Together (15 mL)

The process was performed in the same manner as in Example 1, except that 1 mL of titanium tetraisopropoxide and 15 mL of a hydrogen peroxide aqueous solution were added all together, mixed, and reacted without divided addition of the hydrogen peroxide aqueous solution, and then heated and dried.

### (Example 2) Manufacture of T110/FTO

A titanium oxide thin film was manufactured in the same manner as in Example 1, except that when heat treatment was performed after applying the dispersion, the heat treatment was performed at 110° C. for 5 minutes. This was named T110/FTO.

### (Example 3) Manufacture of T450/FTO

A titanium oxide thin film was manufactured in the same manner as in Example 1, except that when heat treatment was performed after applying the dispersion, heating was performed to 450° C. at a heating rate of 3° C./min under an air atmosphere and then the heat treatment was performed for 30 minutes. This was named T450/FTO.

### (Example 4) Manufacture of T550/FTO

A titanium oxide thin film was manufactured in the same manner as in Example 1, except that when heat treatment was performed after applying the dispersion, heating was performed to 550° C. at a heating rate of 3° C./min under an air atmosphere and then the heat treatment was performed for 30 minutes. This was named T550/FTO.

### (Example 5) Manufacture of T650/FTO

A titanium oxide thin film was manufactured in the same manner as in Example 1, except that when heat treatment was performed after applying the dispersion, heating was performed to 650° C. at a heating rate of 3° C./min under an air atmosphere and then the heat treatment was performed for 30 minutes. This was named T650/FTO.

### (Example 6) Manufacture of T110/Quartz

A titanium oxide thin film was manufactured in the same manner as in Example 2, except that a quartz substrate (SCINCO/Quartz cell) was used instead of an FTO (F-doped tin oxide) substrate. This was named T110/Quartz.

### (Example 7) Manufacture of T110/Quartz (2)

A titanium oxide thin film was manufactured in the same manner as in Example 6, except that applying 10 μl of the dispersion on a quartz substrate and a heat treatment at 110° C. for 5 minutes were set as a unit process, and the unit process was repeated twice. This was named T110/Quartz (2).

### (Example 8) Manufacture of T110/Quartz (4)

A titanium oxide thin film was manufactured in the same manner as in Example 6, except that applying 10 μl of the dispersion on a quartz substrate and a heat treatment at 110° C. for 5 minutes were set as a unit process, and the unit process was repeated 4 times. This was named T110/Quartz (4).

### (Example 9) Manufacture of T110/Quartz (6)

A titanium oxide thin film was manufactured in the same manner as in Example 6, except that applying 10 μl of the dispersion on a quartz substrate and a heat treatment at 110° C. for 5 minutes were set as a unit process, and the unit process was repeated 6 times. This was named T110/Quartz (6).

### (Example 10) Manufacture of T110/Quartz (8)

A titanium oxide thin film was manufactured in the same manner as in Example 6, except that applying 10 μl of the dispersion on a quartz substrate and a heat treatment at 110° C. for 5 minutes were set as a unit process, and the unit process was repeated 8 times. This was named T110/Quartz (8).

### (Example 11) Manufacture of T110/Quartz (10)

A titanium oxide thin film was manufactured in the same manner as in Example 6, except that applying 10 μl of the dispersion on a quartz substrate and a heat treatment at 110° C. for 5 minutes were set as a unit process, and the unit process was repeated 10 times. This was named T110/Quartz (10).

### (Example 12) Manufacture of T25/Al alloy

A titanium oxide thin film was manufactured in the same manner as in Example 1, except that the dispersion was applied on an aluminum alloy panel 3003 H14 (Q-Lab) substrate having a size of 1×4 cm² instead of an FTO substrate by solution casting. This was named T25/Al alloy.

### (Example 13) Manufacture of T110/Al Alloy

A titanium oxide thin film was manufactured in the same manner as in Example 12, except that when the heat treatment was performed after applying the dispersion, the heat treatment was performed at 110° C. for 5 minutes. This was named T110/Al alloy.

### (Example 14) Manufacture of T550/Al Alloy

A titanium oxide thin film was manufactured in the same manner as in Example 12, except that when the heat treatment was performed after applying the dispersion, heating was performed to 550° C. at a heating rate of 3° C./min under an air atmosphere and then the heat treatment was performed for 30 minutes. This was named T550/Al alloy.

### (Example 15) Manufacture of T25/Cu

A titanium oxide thin film was manufactured in the same manner as in Example 1, except that the dispersion was applied on a copper foil (99.9%, Alfa Aesar) substrate having a size of 1×4 cm² instead of an FTO substrate by solution casting. This was named T25/Cu.

### (Example 16) Manufacture of T110/Cu

A titanium oxide thin film was manufactured in the same manner as in Example 15, except that when the heat treatment was performed after applying the dispersion, the heat treatment was performed at 110° C. for 5 minutes. This was named T110/Cu.

### (Comparative Example 1) Manufacture of P25/FTO

0.1 g of TiO₂ nanoparticles (Degussa P25) was added to 1 mL of poly(ethylene glycol) (PEG, molecular weight: 20,000 g/mol, SAMCHUM) aqueous solution (50 wt %) and stirring was performed to obtain a P25 paste. An FTO (F-doped Tin Oxide, visionLab Science, TEC 7) substrate having a 1×1 cm² was coated with the paste by blade coating, heated to 450° C. at a heating rate of 3° C./min, and fired for 30 minutes to manufacture a titanium oxide thin film. This was named P25/FTO.

### (Comparative Example 2) P25/Quartz

A titanium oxide thin film was manufactured in the same manner as in Comparative Example 1, except that a quartz substrate was used instead of the FTO (F-doped Tin Oxide) substrate. This was named P25/Quartz.

### (Comparative Example 3) Manufacture of P25/Al Alloy

A dispersion in which 10 wt % of TiO₂ nanoparticles (Degussa P25) were dispersed in ethanol was applied on an aluminum alloy panel 3003 H14 (Q-Lab) having a size of 1×4 cm² by solution casting, and dried at 110° C. for 5 minutes to manufacture a titanium oxide thin film. This was named P25/Al alloy.

### (Comparative Example 4) Manufacture of P25/Cu

A titanium oxide thin film was manufactured in the same manner as in Comparative Example 3, except that a copper foil (99.9%, Alfa Aesar) was used instead of the aluminum alloy panel. This was named P25/Cu.

### Comparative Example 5

A titanium oxide thin film was manufactured in the same manner as in Example 2, except that the mixture in a gel form was applied on the FTO substrate without heating and drying, adding 20 mL of ethanol, performing sonication, and recovering a supernatant to prepare a dispersion.

### (Evaluation Example 1) Evaluation of Thin Film Properties

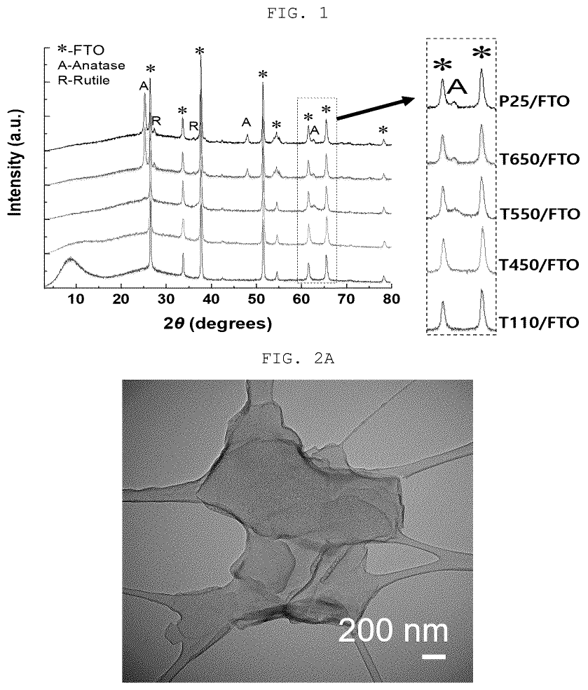

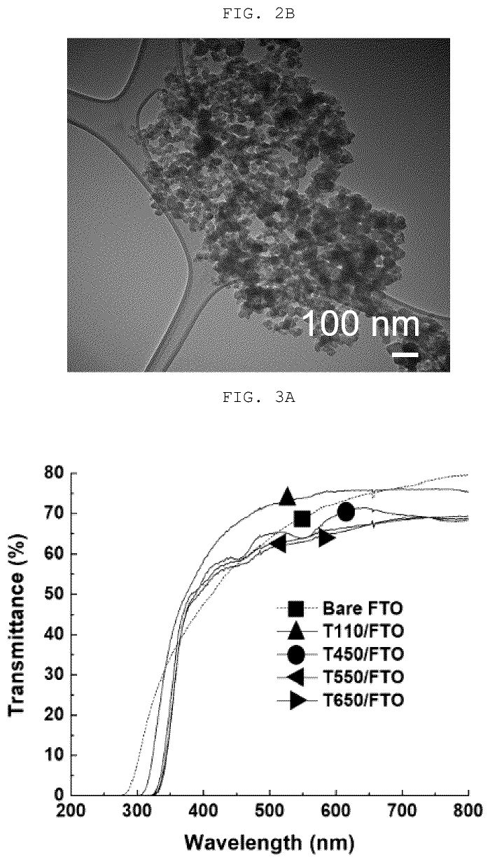

In order to evaluate the crystal structure of the titanium oxide thin film, X-ray diffraction (XRD) analysis was performed. For the X-ray diffraction analysis, X-ray diffraction analyzer (Rigaku, MiniFlex600) using a CuKα radiation (λ=1.5418) was used to perform measurement in a continuous scan mode under the conditions of 20=10° to 80°, scan speed=0.16° s⁻¹, and the results are shown in FIG. 1. In addition, a transmission electron microscope (TEM, H-7600, HITACHI) was used to observe the surface structure of the titanium oxide thin film and is shown in FIGS. 2A and 2B. A sample for TEM analysis was prepared by dispersing the prepared thin film samples in ethanol at a concentration of 0.1 to 1 wt %, dropping the dispersion onto a copper grid coated with porous carbon (holey carbon-coated copper grid, 200 mesh), and drying at 20 to 30° C. for 12 hours to 24 hours.

FIG. 1 is XRD analysis spectra of titanium oxide thin films manufactured in Examples 2 to 5 and Comparative Example 1, respectively. Since only a diffraction peak from FTO was observed and a diffraction peak for titanium oxide was not observed in the titanium oxide thin film of Example 2 (T110/FTO), it was confirmed that an amorphous titanium oxide thin film was manufactured. In addition, a broad peak was observed at 2θ=3° to 15°, and this is due to micropores present in the titanium oxide thin film, and as the heat treatment temperature was increased as in Example 3 (T450/FTO), the peak therefor disappeared. In Example 4 (T550/FTO), a diffraction peak from titanium dioxide of an anatase phase was observed at 2θ=63.1°, and it was confirmed that a crystalline titanium oxide thin film was formed. In Example 5 (T650/FTO), a diffraction peak from titanium dioxide of an anatase phase was detected at 2θ=25.2° and 48.0° as well as diffraction peak at 2θ=63.1°, a diffraction peak from titanium dioxide of a rutile phase was detected at 2θ=27.4° and 36.0°, and it was confirmed that a titanium dioxide thin film in which an anatase phase and a rutile phase coexisted was manufactured. That is, the crystal structure of the titanium oxide thin film was able to be adjusted depending on the heat treatment temperature.

FIG. 2A is a transmission electron microscope image of titanium oxide according to Example 4 and FIG. 2B is a transmission electron microscope image of titanium oxide according to Comparative Example 1. As shown in FIG. 2A, the titanium oxide (Al Alloy/T550) according to Example 4 showed a continuous and homogeneous structure having no void between particles. However, as shown in FIG. 2B, the titanium oxide (P25/FTO) according to Comparative Example 1 showed a heterogeneous structure in which large voids exist between particles due to agglomerates of nanoparticles. Thus, when the titanium oxide thin film was manufactured by the method according to Example 4, it was confirmed that a titanium oxide thin film having a homogeneous structure which is connected as a continuous phase with almost no void was manufactured.

In addition, though it was not shown in the drawings, when the titanium oxide thin film was manufactured by the method of Comparative Example 5, the gel mixture was rapidly applied on a substrate without removing water and hydrogen peroxide, and thus, hydrogen peroxide present in the gel mixture was decomposed during a heat treatment to produce oxygen bubbles, and the structure of the titanium oxide thin film collapsed. Thus, many cracks occurred and the thin film was peeled off from the surface of the substrate and a titanium dioxide thin film having a homogeneous structure was not able to be manufactured. Thus, when the titanium oxide thin film of Comparative Example 5 was manufactured, light transmittance evaluation, adhesion evaluation, and corrosion evaluation described later were not able to be performed.

### (Evaluation Example 2) Evaluation 41 Light of Transmittance

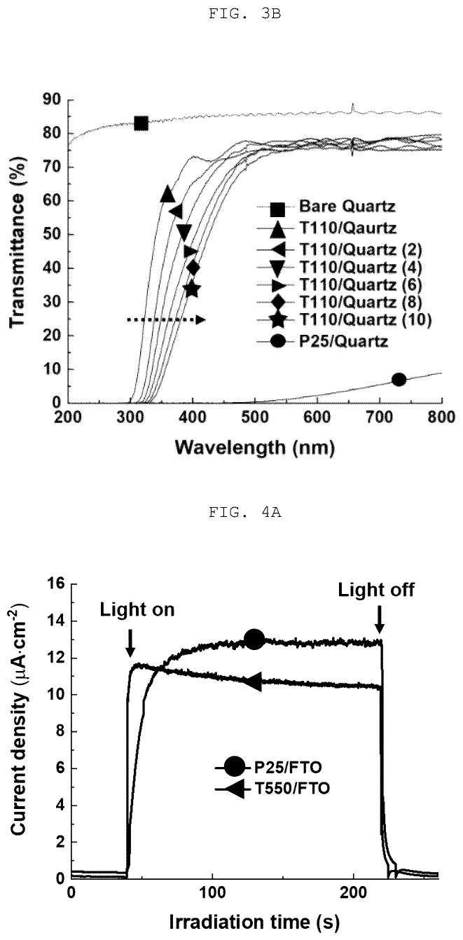

In order to measure the optical properties of the titanium oxide thin film, a light transmittance was measured in a wavelength band of 200 to 800 nm using a UV-visible spectrophotometer (SCINCO) and the results are shown in FIGS. 3A and 3B.

FIG. 3A is a graph of measuring UV-visible transmittance spectra of the titanium oxide thin films according to Examples 2 to 5, and FIG. 3B is a graph of measuring UV-visible transmittance spectra of the titanium oxide thin films according to Examples 6 to 11 and Comparative Example 2, respectively.

Though not shown in FIGS. 3A and 3B, in a visible light region of 400 to 700 nm, the titanium oxide thin film of Comparative Example 1 (P25/FTO) showed a low visible light transmittance of 10% or less. The titanium oxide thin film of Comparative Example 1 manufactured using P25 which is a nanoparticle agglomerate had significantly low transparency due to the occurrence of strong light scattering in a grain boundary.

The titanium oxide thin film manufactured by the methods according to Examples 2 to 5 showed a high light transmittance equivalent to bare FTO which does not include the titanium oxide thin film, regardless of the heat treatment temperature, and thus, titanium oxide thin film having excellent transparency was manufactured. When the titanium oxide thin film was manufactured by the methods according to Examples 2 to 5, it was confirmed that since titanium oxide was connected as a continuous phase and had almost no void, a titanium oxide thin film having high transparency was manufactured.

In addition, though not shown in the drawing, when the transparency of Examples 1-1 and 1-2 in which a hydrogen peroxide aqueous solution was added all together and transparency of Example 1 in which the hydrogen peroxide aqueous solution was added in a divided manner were compared, Example 1 showed the best transparency. Though Example 1-1 did not have a large difference in transparency from Example 1, Example 1 had a decreased amount of the remaining light yellow precipitate due to the divided addition and showed significantly high transparency as compared with Example 1-2.

Meanwhile, the titanium oxide thin films according to Examples 2 to 5 showed a higher visible light transmittance than bare FTO in some visible light regions, and this was considered to be the results of interference of light reflected on the titanium oxide thin film.

Bare Quartz cell which did not include the titanium oxide thin film showed a light transmittance of 75% or more in all of the measured wavelength band, and the titanium oxide thin film of Comparative Example 2 (P25/Quartz) showed a low visible light transmittance of 10% or less in the visible light region of 400 to 700 nm. The titanium oxide thin film of Comparative Example 2 manufactured using P25 which is a nanoparticle agglomerate had significantly low transparency due to the occurrence of strong light scattering in a grain boundary.

However, in Example 6 (T110/Quartz), light was almost completely absorbed in the wavelength band of 300 nm or less corresponding to ultraviolet rays, and a high light transmittance of 70% or more was shown in the visible light wavelength band of 450 nm or more. Thus, it was confirmed that the titanium oxide thin film of Example 6 densely covered the surface of Quartz as the substrate, and the titanium oxide thin film absorbed ultraviolet rays.

Upon comparison of Examples 7 to 11 in which a dispersion coating process and a drying process were set as a unit process and the unit process was repeated multiple times to increase the thickness of the titanium oxide thin film, as the number of unit processes is increased, the thin film thickness was increased, and thus, a light absorption rate for the UV wavelength band of 290 to 350 nm was greatly increased. Thus, it was confirmed that the titanium oxide thin film manufactured by the method according to an exemplary embodiment of the present disclosure was able to be used as a UV protection film.

### (Evaluation Example 3) Evaluation of Adhesion

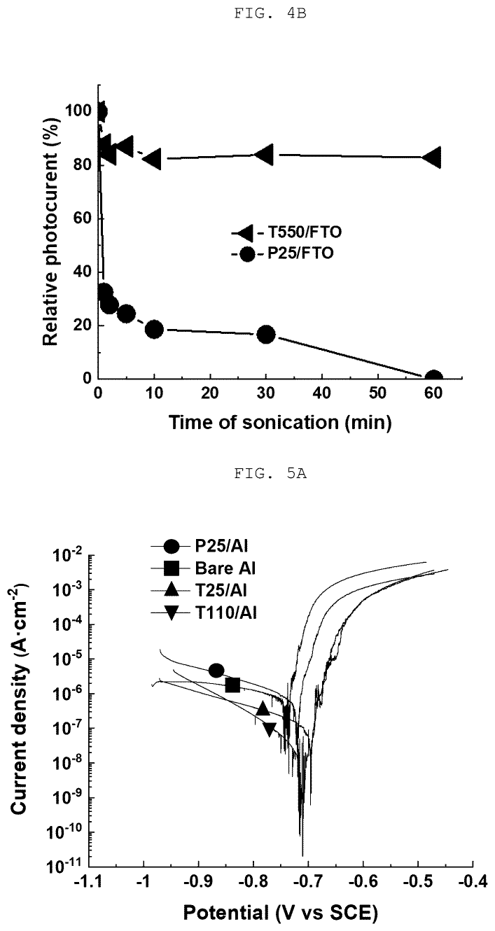

In order to evaluate the performance of the titanium oxide thin film when it was used as a photocatalyst, a photocurrent production experiment was performed. Photocurrent measurement was performed by immersing an electrode in a 10 mM NaOH aqueous solution, and a titanium oxide thin film, Ag/AgCl, and a Pt plate were used as a working electrode, a reference electrode, and a counter electrode, respectively. The photocurrent was measured under application of potential bias (0.5 V vs Ag/AgCl), using an electrochemical instrumentation (potentiostat, Gamry) connected to a computer. For the photocurrent test, 300 W Xe arc lamp (Oriel) equipped with a water filter was used as a light source. Light was filtered with an AM 1.5 filter, and focused on a light reactor with a quartz window. During measurement of photocurrent, the reactor was continuously stirred using a magnetic stirrer. The results of photocurrent production experiment are shown in FIG. 4A.

In addition, in order to evaluate the adhesion of the titanium oxide thin film, the working electrode was immersed in deionized water, sonicated with energy of 60 Hz and 100 W, and dried at 110° C. for 1 hour, and then the photocurrent production experiment was performed by the method described above. At this time, after 10 minutes of irradiation with a light source, the photocurrent of the working electrode which reached a steady state was measured and the results are shown in FIG. 4B.

FIG. 4A is a graph of measuring photocurrent production and FIG. 4B is a graph of measuring a steady state photocurrent production of the titanium oxide thin films manufactured by the methods according to Comparative Example 1 (P25/FTO) and Example 4 (T550/FTO).

FIG. 4A is measurement of photocurrent production using a titanium oxide thin film to which ultrasonic vibration was not applied before performing the photocurrent production experiment, and in the state in which the adhesion of the electrode was not inhibited by ultrasound, the electrodes of Comparative Example 1 (P25/FTO) and Example 4 (T550/FTO) produced similar amounts of photocurrent. However, as shown in FIG. 4B, when ultrasonic vibration was applied to the titanium oxide thin film for a certain period of time and then the photocurrent production experiment was performed, there was a big different in the photocurrent production ability in the steady state of Comparative Example 1 (P25/FTO) and Example 4 (T550/FTO). The titanium oxide of Example 4 (T550/FTO) produced steady state photocurrent which reached 80% or more of the initial value even when the photocurrent production experiment was performed after applying ultrasonic vibration for 1 hour. However, in Comparative Example 1 (P25/FTO), ultrasonic vibration was applied for 1 minute, the stead state photocurrent production was rapidly decreased to about 30% of the initial value, and when the ultrasonic vibration was applied for 1 hour, the steady state photocurrent production was close to 0% to the initial value and significant catalytic activity reduction occurred. Comparative Example 1 in which the titanium oxide nanoparticle agglomerate was unevenly coated on the substrate had low adhesion due to a weak interaction between the substrate and titanium oxide. However, since the titanium oxide thin film of Example 4 bonded to many reaction groups on the surface of the substrate and had a homogeneous continuous phase, it was confirmed to have excellent adhesion to a substrate even without a binder and have high utility as a photocurrent film.

### (Evaluation Example 4) Evaluation of Corrosion Resistance

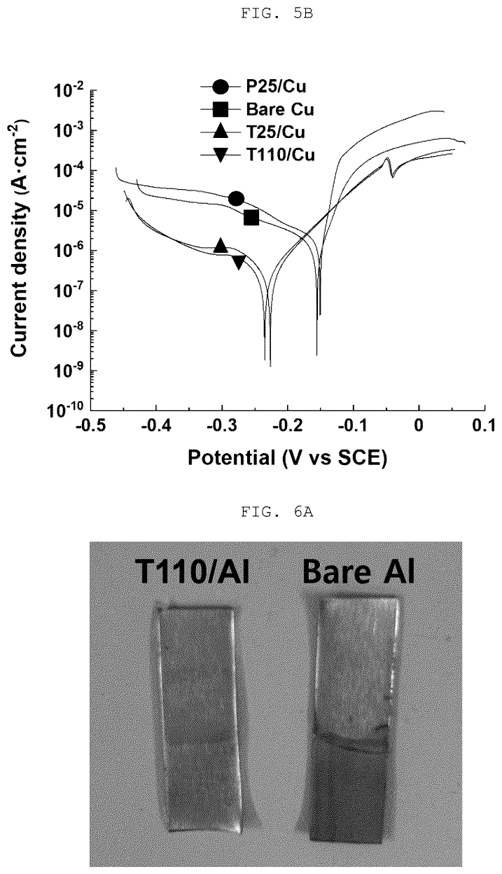

In order to evaluate corrosion resistance of the titanium oxide thin film, a potentiodynamic polarization (PDP) test was performed. The potentiodynamic polarization test was performed in a 3.5 wt % NaCl aqueous solution, and a titanium oxide thin film, an aluminum alloy panel, or a copper foil was used as a working electrode, a saturated calomel electrode (SCE) was used as a reference electrode, and a Pt plate was used as a counter electrode. After at least 60 minutes of reaching steady state conditions during the potentiodynamic polarization test, a sample polarized at ±250 mV for the oxidation and reduction potential under steady state conditions was measured at a scan speed of 0.167 mV·s⁻¹. The measurement results are shown in FIGS. 5A and 5B. In addition, inhibition efficiency and corrosion rate were calculated by the following Equations 1 and 2 and are shown in Table 1.

$$Corrosion inhibition efficiency ( \% ) = ( 1 - \frac{C {R}_{coated}}{C {R}_{uncoated}} ) \times 100 \% \qquad [ Equation 1 ]$$

wherein CR_{coated} is a corrosion degree of a substrate including a titanium oxide thin film, and CR_{uncoated} is a corrosion degree of a substrate including no titanium oxide thin film,

$$Corrosion degree = \frac{Icorr \times K \times E W}{ρ A} \qquad [ Equation 2 ]$$

wherein Icorr is a corrosion current density, K is a corrosion constant (=3272 mm·year⁻¹), EW is an equivalent of a substrate, p is a density of a substrate, and A is an area of a substrate immersed in a NaCl aqueous solution.

TABLE 1

| | | Corrosion | | Corrosion |
|---|---|---|---|---|
| | Corrosion | current | Corrosion | inhibition |
| | potential | density | degree | efficiency |
| | [mV] | [A · cm⁻²] | [mm · year⁻¹] | [%] |
| Bare Al alloy | −738.0 | 9.70 × 10⁻⁷ | 5.23 × 10⁻³ | N/A |
| Comparative | −720.0 | 7.00 × 10⁻⁷ | 3.77 × 10⁻³ | 27.8% |
| Example 3 | | | | |
| Example 12 | −709.0 | 3.17 × 10⁻⁷ | 1.71 × 10⁻³ | 67.3% |
| Example 13 | −706.0 | 2.67 × 10⁻⁸ | 1.44 × 10⁻⁴ | 97.2% |
| Bare Cu | −152.0 | 1.49 × 10⁻⁶ | 8.66 × 10⁻³ | N/A |
| Comparative | −149.0 | 1.51 × 10⁻⁶ | 8.78 × 10⁻³ | −1.34% |
| Example 4 | | | | |
| Example 15 | −227.0 | 2.94 × 10⁻⁷ | 1.71 × 10⁻³ | 80.3% |
| Example 16 | −235.0 | 2.91 × 10⁻⁷ | 1.69 × 10⁻³ | 80.5% |

FIG. 5A is polarization curves of bare Al alloy and the titanium oxide thin films according to Example 12 (T25/Al alloy), Example 13 (T110/Al alloy), and Comparative Example 3 (P25/Al alloy), and FIG. 5B is polarization curves of bare Cu and the titanium oxide thin films according to Example 15 (T25/Cu), Example 16 (T110/Cu), and Comparative Example 4 (P25/Cu).

Referring to Table 1 and FIG. 5A, the bare Al alloy including no titanium oxide thin film had a corrosion current density (Icorr) of 9.70×10⁻⁷ A·cm⁻² and a corrosion rate (CR) of 5.23×10⁻³ mm·year⁻¹. However, Example 13 (T110/Al) having a titanium oxide thin film on the surface of an aluminum alloy panel had a corrosion current density (Icorr) of 2.67×10⁻⁸ A·cm⁻² and a corrosion rate (CR) of 1.44×10⁻⁴ mm·year⁻¹. That is, it was confirmed that Example 13 (T110/Al) had an excellent corrosion prevention effect reaching to the corrosion inhibition efficiency of 97.2%. Referring to Table 1 and FIG. 5B, an excellent corrosion prevention effect of the corrosion inhibition efficiency of more than 80% was also observed in Examples 15 and 16 in which the titanium oxide thin film was formed on a copper foil.

Meanwhile, it was shown that Comparative 3 (P25/Al alloy) and Comparative Example 4 (P25/Cu) coated with P25 had a very small or no corrosion prevention effect. The titanium oxide thin film of Comparative 3 (P25/Al alloy) had the corrosion inhibition efficiency of 27.8% and the corrosion inhibition efficiency of Example 4 (P25/Cu) was-1.34% which was very low. It was confirmed that the titanium oxide thin films of Comparative Examples 3 and 4 on which the titanium oxide nanoparticle agglomerate was formed had no corrosion inhibition effect since the diffusion of the corrosive fluid was not prevented.

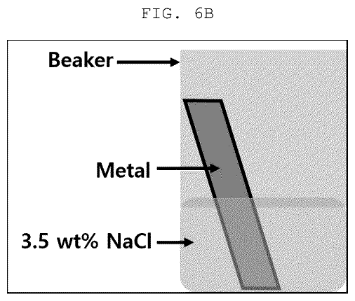

In addition, as shown in FIG. 6B, the titanium oxide thin film of Example 13 (T110/Al alloy) and the bare aluminum alloy panel (Bare Al alloy) including no titanium oxide were immersed in a 3.5 wt % of NaCl aqueous solution, stirred, and maintained for 3 days to perform an immersion corrosion test. The results are shown in FIG. 6A.

FIG. 6A is a photograph in which the surfaces of Example 13 (T110/Al alloy) and the bare aluminum alloy panel (Bare Al alloy) were observed, after performing the immersion corrosion test by the method described above. Referring to FIG. 6A, the corrosion prevention effect of the titanium oxide thin film according to Example 13 was visually clearly shown. Though the part immersed in the NaCl aqueous solution of the bare aluminum alloy panel was covered with rust, there was no difference between the immersed part in the NaCl aqueous solution and the part which was not immersed in Example 13 (T110/Al alloy). It was found that since the titanium oxide thin film was placed on the aluminum alloy panel, rust was not produced even with immersion in the NaCl aqueous solution for a long time and had a significant corrosion prevention effect.

The method for manufacturing a titanium oxide (TiOₓ) thin film of the present disclosure may manufacture a structurally homogeneous titanium oxide (TiOₓ).

The method for manufacturing a titanium oxide (TiOₓ) thin film of the present disclosure may minimize a peroxotitanic acid precipitate to manufacture a homogeneously coated titanium oxide thin film.

Since the method for manufacturing a titanium oxide (TiOₓ) thin film of the present disclosure does not produce oxygen bubbles in the thin film during drying, a structurally homogeneous titanium oxide (TiOₓ) thin film of which the structure does not collapse may be manufactured.

The method for manufacturing a titanium oxide (TiOₓ) thin film of the present disclosure may manufacture a high quality transparent titanium oxide (TiOₓ) thin film within a short time.

The xerogel titanium oxide (TiOₓ) thin film of the present disclosure may be structurally homogeneous, have an excellent corrosion inhibition effect, and have excellent adhesion to a substrate without a binder.

Hereinabove, although the present invention has been described by specific matters, limited exemplary embodiments, and drawings, they have been provided only for assisting the entire understanding of the present invention, and the present invention is not limited to the exemplary embodiments. Various modifications and changes may be made by those skilled in the art to which the present invention pertains from the description.

Therefore, the spirit of the present invention should not be limited to the above-described exemplary embodiments, and the following claims as well as all modifications equal or equivalent to the claims are intended to fall within the scope and spirit of the invention.

What is claimed is:

1. A method for manufacturing a titanium oxide (TiOₓ) thin film, the method comprising:
(S10) mixing a titanium precursor and a peroxide aqueous solution to prepare a gel mixture including a titanium oxide (TiOₓ);
(S20) heating the gel mixture to prepare a titanium oxide (TiOₓ) gel from which a peroxotitanic acid precipitate, a peroxide, and water have been removed;
(S30) preparing a dispersion in which the titanium oxide (TiOₓ) gel is dispersed in a solvent;
(S40) applying the dispersion on a substrate; and
(S50) heat treating the substrate on which the dispersion has been applied.

2. The method for manufacturing a titanium oxide (TiOₓ) thin film of claim 1, wherein in (S10), the peroxide aqueous solution is added in a divided manner.

3. The method for manufacturing a titanium oxide (TiOₓ) thin film of claim 1, wherein in (S30), the dispersion is prepared by sonicating the solvent to which the titanium oxide gel is added.

4. The method for manufacturing a titanium oxide (TiOₓ) thin film of claim 1, wherein in (S20), the heating is performed under temperature conditions of 50 to 200° C.

5. The method for manufacturing a titanium oxide (TiOₓ) thin film of claim 1, wherein in (S50), the heat treating is performed for 1 minute to 24 hours.

6. The method for manufacturing a titanium oxide (TiOₓ) thin film of claim 1, wherein the titanium precursor includes titanium alkoxides.

7. The method for manufacturing a titanium oxide (TiOₓ) thin film of claim 1, wherein (S40) and (S50) are set as a unit process and the unit process is performed at least once.

8. The method for manufacturing a titanium oxide (TiOₓ) thin film of claim 1, wherein (S50) is performed at 10 to 1000° C.

9. A xerogel titanium oxide (TiOₓ) thin film manufactured by the method of claim 1.

10. The xerogel titanium oxide (TiOₓ) thin film of claim 9, wherein the xerogel titanium oxide thin film has a light transmittance in a wavelength band of 300 to 800 nm of 70% or more.

11. The xerogel titanium oxide (TiOₓ) thin film of claim 9, wherein the xerogel titanium oxide thin film has a corrosion inhibition efficiency represented by the following Equation 1 of 65% or more:
$$Corrosion inhibition efficiency ( \% ) = ( 1 - \frac{C {R}_{coated}}{C {R}_{uncoated}} ) \times 100 \% \qquad [ Equation 1 ]$$
wherein CR_{coated} is a corrosion degree of a substrate including the xerogel titanium oxide (TiOₓ) thin film, and CR_{uncoated} is a corrosion degree of a substrate which does not include the xerogel titanium oxide (TiOₓ) thin film.
